(19) United States
(12) Patent Application Publication
(10) Pub. No.: US 2023/0143114 A1
(43) Pub. Date: May 11, 2023

(54) A SYSTEM AND A METHOD FOR FLUORESCENCE DETECTION

(71) Applicant: HIFIBIO (HK) LIMITED, Central, Hong Kong (CN)

(72) Inventors: Evelio Esteban Ramírez Miquet, Paris (FR); Annabelle Patricia Veronique Gérard, Palaiseau (FR)

(21) Appl. No.: 17/917,991

(22) PCT Filed: Apr. 14, 2021
(86) PCT No.: PCT/CN2021/087281

§ 371 Date: Oct. 10, 2022

(30) Foreign Application Priority Data
Apr. 15, 2020 (EP) 20315174.1

(51) Int. Cl. G01N 21/64; G01N 21/01

(52) U.S. Cl. CPC G01N 21/6458; G01N 21/6428; G01N 21/01; G01N 21/6402; G01N 2021/6419; G01N 2021/6439

(57) ABSTRACT

A system (100) and a method for detecting fluorescence is disclosed. The system (100) essentially comprises a labelled sample wherein said labelled sample emits an electromagnetic radiation of a defined wavelength when irradiated by a LASER beam of a commensurate wavelength, a source (102) for emitting said LASER beam, oriented as to aim at said labelled sample, a chamber for holding said labelled sample during said LASER irradiation, a reflective layer (108) positioned to reflect said electromagnetic radiation, and a detector (112) positioned to detect and amplify said electromagnetic radiation. The method essentially comprises the steps of providing a labelled sample wherein said labelled sample emits an electromagnetic radiation of a defined wavelength when irradiated by a LASER beam of a commensurate wavelength, providing a source (102) for emitting said LASER beam, oriented as to aim at said labelled sample, providing a chamber for holding said labelled sample during said LASER irradiation, providing a reflective layer (108) positioned to reflect said electromagnetic radiation, providing a detector (112) positioned to detect and amplify said electromagnetic radiation, irradiating said sample with said LASER beam and analyzing said amplified electromagnetic radiation from said detector (112) with a signal processing block (114).

### BACKGROUND

Flow cytometry is a technique used to detect and measure the physical and chemical characteristics of a population of any organic or inorganic particles. For the case of a cell, this is based on one or more properties such as cell surface markers and DNA. Moreover, this technique is used for analyzing secreted/excreted expressions of cell surfaces and intracellular molecules, characterizing and defining different cell types in a heterogeneous cell population, enriching (for cells having phenotype of interest) and assessing the purity of isolated subpopulations and analyzing cell size, granulosity and volume. Thus, flow cytometry makes possible a simultaneous multi-parameter analysis of cells.

The Fluorescence Activated Cell Sorter (FACS) was invented in the late 1960s by Bonner, Sweet, Hulett, Herzenberg, and others to do flow cytometry and cell sorting of viable cells. Becton Dickinson Immunocytometry Systems introduced the commercial machines in the early 1970s. Fluorescence Activated Cell Sorting (FACS) is a specialized type of flow cytometry. It provides a method for sorting a heterogeneous mixture of biological cells into two or more containers, one cell at a time, based upon the specific light scattering and the fluorescent characteristics of each cell. It is a useful scientific instrument, as it provides fast, objective and quantitative recording of fluorescent signals from individual cells and thereby the suitable physical separation of cells of particular interest.

The cell suspension is entrained in the center of a narrow, rapidly flowing stream of liquid. The flow is arranged so that there is a large separation between cells relative to their diameter. A vibrating mechanism causes the stream of cells to break into individual droplets. The system is adjusted so that there is a low probability of more than one cell per droplet. Just before the stream breaks into droplets, the flow passes through a fluorescence measuring station where the fluorescent character of interest of each cell is measured. An electrical charging ring is placed just at the point where the stream breaks into droplets. A charge is placed on the ring based on the immediately prior fluorescence intensity measurement, and the opposite charge is trapped on the droplet as it breaks from the stream. The charged droplets then fall through an electrostatic deflection system that diverts droplets into containers based upon their charge. In some systems, the charge is applied directly to the stream, and the droplet breaking off retains charge of the same sign as the stream. The stream is then returned to neutral after the droplet breaks off.

A wide range of fluorophores can be used as labels in flow cytometry. Fluorophores, or simply “fluors.” are typically attached to an antibody that recognizes a target feature on or in the cell; they may also be attached to a chemical entity with affinity for the cell membrane or another cellular structure or another cellular entity. Each fluorophore has a characteristic peak excitation and emission wavelength, and the emission spectra often overlap. Consequently, the combination of labels which can be used depends on the wavelength of the lamp(s) or laser(s) used to excite the fluorochromes and on the detectors available.

Fluorescence-activated cell sorting (FACS) provides a rapid means of isolating large numbers of fluorescently tagged cells from a heterogeneous mixture of cells. Collections of transgenic cell lines with cell type-specific expression of fluorescent marker genes such as green fluorescent protein (GFP) are ideally suited for FACS-assisted studies of individual cell types.

It has been demonstrated that flow cytometric analysis and fluorescence activated cell sorting (FACS) of plant protoplasts is practicable, moreover, this technique has yielded valuable results in a number of different fields of research (Harkins and Galbraith, 1984: Galbraith et al., 1995; Sheen et al., 1995). For instance, FACS of protoplasts from Arabidopsis plants expressing tissue-specific fluorescent protein markers has been used to examine both basal and environmentally stimulated transcriptional profiles in particular cell types (Birnbaum et al., 2003: Brady et al., 2007: Gifford et al., 2008; Dinneny et al., 2008) and flow cytometry has been employed to analyze reactive oxygen species production and programmed cell death tobacco protoplasts (Nicotiana tabacum; Lin et al., 2006). A broad selection of fluorescent tools is available to study a plethora of physiological parameters in plants, e.g., cis-regulatory elements fused to fluorescent proteins (Haseloff and Siemering, 2006), genetically encoded molecular sensors (Looger et al., 2005) or dye-based sensors (Haugland, 2002) can be used in combination with cytometry to measure diverse biological processes.

Another pivotal application involves cell sorting of mammalian cells based upon stated technique. For example, FACS for Escherichia coli lacZ gene has been adapted for use in mammalian cells and has shown utility as a marker for the expression of chimeric genes (Proc. Natl. Acad. Sci. USA Vol. 85, pp. 2603-2607, April 1988 Cell Biology). With the recent development of reporter genes detectable by flow cytometry, it has become possible to analyze the expression of a transcriptional element within an individual mammalian cell. The articles by Nolan et al. in PNAS USA 85:2603-2607 (1985) and Fiering et al. in Cytometry 12: 291-301 (1991) describe FACS-Gal, a fluorogenic assay that permits the detection and isolation of individual cells expressing lac7. The gene lac7, encodes the enzyme B-galactosidase, which cleaves the non-fluorescent Substrate fluorescein-di-B-galactopyranoside to release fluorescein.

Fluorescence Activated Droplet Sorting (FADS) is a specialized type of microfluidic sorting, based upon the principles of FACS. FADS measures the distribution of fluorescence intensity produced by fluorescent-labeled proteins on or within a particle, as well as within or on the surface of a droplet. Further, FADS is used for sorting a heterogenous mixture of populations of droplets into a plurality of containers. It should be noted that the sorting is based upon analyzing the fluorescent characteristics of each droplet or a doublet thereof i.e. one or two droplets at a time. Typically, the heterogeneous mixture of droplets contains a mix of detectable labels such as fluorescent dyes. Furthermore, when LASER light falls on a droplet, the dyes get irradiated. Due to the irradiation of the dyes, fluorescence is emitted. Thereafter, the emitted fluorescence is observed for variations to detect the appropriate characterization and categorization of each droplet.

Microfluidic droplet flow cytometry eliminates the need for vacuum containment systems and facility additions to protect operators against aerosolized pathogen exposure in conventional fluorescence activated droplet sorting (FADS). In addition, other lab-on-a-chip devices, the potential exists for further functionality integrated on-chip, such as sample preparation, cell incubation, chemical analysis, PCR, or other assays of the sorted populations. Specifically, these capabilities would enable sorting and molecular analysis of rare cells in blood such as circulating tumor cells (CTCs), circulating antigen specific B or T cells, providing powerful molecular diagnostic information concerning cancer drug resistance in a non-invasive manner for personalized therapies and/or discovering novel therapeutics candidates from patient samples.

Droplet microfluidics was first presented in the early 21st century and has since then proven itself a suitable technology for high-throughput screening of chemical and biological assays. The technology relies upon the controlled generation of isolated droplets in a two-phase system. The fluid making up the droplets is termed the dispersed phase, aqueous phase or sample phase, and this is typically a water or a water-based solution or suspension. The surrounding fluid is termed the continuous phase, the hydrophobic phase, oil-phase or sheath phase this is usually a nonpolar fluid, such as fluorocarbon oil, silicone oil, or vegetable oil, which is combined with water-based droplets to an emulsion. Surfactants are often added to both the dispersed and the continuous phase for increased droplet stability. The key feature of droplet microfluidics is the generation of monodisperse droplets that are completely isolated from each other, serving as miniaturized reaction vessels. The capability of creating individual reaction vessels on the scale of pico-liter to nanoliter volumes is extremely attractive for high-throughput biological assays such as single-cell analysis, and the research field is rapidly growing. The success of the droplet microfluidic platform can further be appreciated by the fact that the technology has made it into several commercial systems such as the flow cytometers by BD Biosciences, the 10× Genomix platform for single-cell RNA analysis, and the analysis tools for digital PCR provided by Raindance Technologies. To establish complete assays on-chip, several different microfluidic unit operations need to be integrated into a complete microfluidic circuit. A range of solutions to allow for the generation of droplets, encapsulation of cells and particles, introduction and mixing of liquids in the droplets, incubation, and finally analysis of the reactions that have occurred are available today, and these methods have been carefully covered in several recent review articles. For biological assays, microparticles (such as affinity beads and cells) are usually encapsulated inside the droplets, thus also bringing a need to control these particles inside the droplets, for example, to enrich or sort them. Further, there is also a need to manipulate the droplets themselves in the microfluidic network for similar purposes. Several microparticle manipulation techniques have therefore been developed for droplet microfluidics, to manipulate encapsulated microparticles, here termed droplet internal manipulation, as well as to manipulate the individual droplets for sorting.

Droplets can be sorted by size by using the hydrodynamic method of pinched flow fractionation (PFF). Droplets that are smaller than the cross-section of the microfluidic channel follow the flow paths determined by the continuous phase. In PFF, the particles are focused to one side in a pinched segment and thereby follow different streamlines depending on their size at a broadening of this segment. An application of PFF is the one described by Maenaka et al., where oil-in-water droplets of different diameters (3.8±1.5 μm, 28.8±7.4 μm, and 47.7±7.4 μm) were sorted into different outlets. Cao et al. have demonstrated another hydrodynamic approach where the default flow path would lead all water-in oil-droplets into a waste channel and the on-demand activation of an external solenoid valve selectively deflects the droplets of interest into a collection channel with a modest throughput of ˜30 Hz. Mazutis and Griffiths demonstrated hydrodynamic size fractionation of droplets at throughputs exceeding 4.5 kHz. Their method relied on pinching larger droplets along the vertical axis in the center of the channel restricting the movement of smaller droplets to flow near the channel walls around the larger droplets. This caused a size fractionation of droplets with a difference in volume as small as 2.33-fold. In their system, they separated the smaller droplets by incorporating a trifurcation where the larger droplets exited via the center outlet and the smaller droplets exited via the two side outlet channels. Finally, deterministic lateral displacement (DLD). In their work, they sorted aqueous droplets containing yeast cells by size where the droplets were either 11 or 30 μm, resulting from the metabolic activity of the encapsulated yeast cells. One benefit of the passive hydrodynamic technique for whole droplet manipulation is that it does not rely on any external equipment other than a pump. As a result, it can be parallelized for increased throughput which is often not the case for active techniques where external equipment and integrated sensors and actuators put a limit on the scalability.

High throughput in droplet sorting is crucial in applications where large sample volumes are processed or in applications where the sample is extremely rare such as in directed evolution and in applications focused on isolating tumor cells, and to date, dielectrophoresis holds the record. The first report on DEP sorting was by Ahn et al. where they showed sorting rates up to 4 kHz for water-in-oil droplets with diameters from 4 to 60 μm, and since then, this manipulation method has become the gold standard for droplet sorting; and it has been implemented by several research groups. For activation, the DEP sorting is most commonly equipped with an optical detection system, configured into a fluorescence activated droplet sorting (FADS) platform. One such application is the FADS sorting presented by Baret et al. where the sorting criterion was based on the fluorescence signal from the enzymatic activity within the droplets. The fastest DEP droplet sorting device presented to date is the one reported by Sciambi and Abate capable of sorting rates of 30 kHz for 25 μm diameter water-in-oil droplets. This is a very impressive throughput, but the downside is that systems incorporating DEP are often complex and rely on external driving electronics which may be a limitation for some application areas.

Magnetic-based droplet manipulation can be applied when the droplets contain magnetic particles or ferrofluids. The magnetic fields are usually provided by external permanent magnets, but electromagnets can also be used, as demonstrated by Teste et al. who achieved whole droplet manipulation by using ferromagnetic rails. Zhang et al. demonstrated continuous magnetic droplet manipulation, of ferrofluid filled pico-liter droplets in oil at rates up to 10 Hz by an external permanent magnet. However, droplet sorting by MAP is limited by the actuation speed of the permanent magnets resulting in a low throughput. Nevertheless, the throughput can be somewhat increased by the use of electromagnets but then again with the cost of a more complex setup.

Acoustic manipulation can be applied to manipulate whole droplets, using both the surface acoustic wave SAW and the bulk acoustic wave BAW operation modes. Several groups have shown that both standing surface acoustic waves SSAW and traveling surface acoustic waves TSAW can be used to sort droplets either at a bifurcation channel split or at a multichannel outlet with throughput up to 3 kHz for droplets as small as 20 μm in diameter (˜4 pL volume) and for elongated droplets as large as 2.6 nL in volume. BAW manipulation methods have been applied to sort whole droplets, both oil-in-water droplets and water-in-oil droplets. The microfluidic system is designed so that the default flow path of the droplets is toward the waste outlet due to its lower hydrodynamic resistance. The primary acoustic radiation force is then used to selectively affect the droplets so that they instead follow the flow path toward the collection channel. Lee et al. sorted 50 and 100 μm diameter oleic acid droplets in an aqueous continuous phase with a 99.3% and 85.3% efficiency, respectively, at a rate of 60 Hz. Leibacher et al. demonstrated merging and sorting of 200 μm diameter aqueous droplets in an organic continuous phase with a throughput of <10 Hz by placing the droplets at the acoustic pressure nodal lines These reported acoustic sorting methods are today considerably slower than the DEP sorting techniques, but they have the advantage of being independent of the electrical conductivity of both the dispersed and the continuous phase. When choosing between the SAW and BAW operation modes, the BAW approach has the advantage of a simpler acoustic transducer setup since BAW does not require custom integrated transducers but instead relies on externally mounted transducers which are a readily available retail technology. On the other hand, the BAW mode is the slower of the two acoustic whole droplet manipulation techniques, having problems surpassing a throughput of 100 Hz.

Another category of methods to manipulate whole droplets involves the application of heat to the droplet system. Yap et al. have shown the implementation of a microheater at a microchannel bifurcation for on-demand control of water-in-oil droplets (approximately 100 μm wide, 200 μm long, and 30 μm high).

Now, such fluorescence released from FADS can get scattered in all directions i.e. 360° and can thus result in reduced efficiency of the detection of fluorescence emitted from the particle/droplet. Therefore, there is a need for a system and a method for improving fluorescence detection which results in increased efficiency, power, and gain of the fluorescence detection system.

### SUMMARY OF THE INVENTION

The present invention generally relates to a system and a method for fluorescence (or luminescence) detection. The subject matter of the of the present invention involves an alternative solution to a particular problem by combining a microfluidics system with a system for optimized fluorescence detection, wherein a lens for focusing an excitation beam, a dichroic mirror and an reflective layer positioned behind a sample are combined with a microfluidics system for encapsulating and sorting sample material in separate droplets and subjecting them to fluorescence analysis (see FIGS. 1 and 5, for example). The combination of said technical features achieves the surprising result of improved fluorescence detection on a single cell basis combined with the immediate sorting of analyzed droplets comprising a sample and/or a cell according to detection or absence of a fluorescence signal from respective droplets. The loss of electromagnetic radiation or fluorescence signal emitted from a sample upon irradiation by an excitation beam and/or of luminescence emitted from the sample within a droplet is surprisingly reduced by the incorporation of a reflective layer behind the droplets comprising a sample according to the present invention. The reflective layer enables the reflection of the fluorescence that is scattered and/or emitted away from the first dichroic mirror (in the opposite direction of the first dichroic mirror), back towards the first dichroic mirror which then directs the florescence towards the detectors or detection/analysis area. Therefore, the effect of the feature of the reflective layer positioned behind a sample, which is encapsulated in a droplet inside a microfluidic channel, is the amplification and enhancement of emitted electromagnetic radiation from a sample, which results together with the microfluidic system in the surprisingly improved fluorescence detection on a single cell or sample basis.

In one aspect, the present invention is generally directed to a system for detecting fluorescence. In one set of embodiments, the system comprises a labelled sample wherein said labelled sample emits an electromagnetic radiation of a specific wavelength range when irradiated by a LASER beam of a corresponding specific wavelength range, a source for emitting said LASER beam oriented as to aim at said labelled sample, a chamber for holding said labelled sample during said LASER irradiation, a reflective layer positioned to reflect said electromagnetic radiation, and a detector positioned to detect and optionally amplify said electromagnetic radiation. Herein, the excitation source can be a LASER, a light emitting diode (LED) or a light bulb, which is coupled with a narrow bandpass filter that enables the fluorescence to be generated without overlapping with the spectral emission of the excitation source, such as an LED. The labelled sample may be present inside a microfluidic channel of a microfluidic chip or a specific chamber or part thereof during said irradiation, wherein the sample may be encapsulated within a droplet that passes through the microfluidic channel of the microfluidic chip or a specific chamber or part thereof (see, for example, FIGS. 3 and 4).

In one set of embodiments, the system additionally comprises a first and a second dichroic mirror, said first dichroic mirror positioned between said source and said chamber, said second dichroic mirror positioned between said first dichroic mirror and said detector, wherein said first dichroic mirror deflects said electromagnetic radiation reflected from said reflective layer towards said second dichroic mirror which further deflects to said detector. In more detail, the first dichroic mirror transmits the laser radiation coming from the laser sources towards the microfluidic chip or chamber. The radiation that comes back from the microfluidic chip (reflected laser(s) at the droplet surfaces plus the fluorescence) is reflected by the first dichroic mirror towards the secondary dichroic mirror but only when it comes from the microfluidic chip. That said, the first dichroic is transparent to the lasers in one direction and perfectly reflective in the opposite direction for both the lasers and the fluorescence.

In one embodiment, the system further comprises a lens for focusing and shaping said excitation or LASER beam on said sample and a signal processing block for analyzing said detector-amplified electromagnetic radiation.

In another aspect, the present invention relates to a method for detecting and or reflecting the fluorescence according to said system comprising the steps of providing a labelled sample wherein said labelled sample emits an electromagnetic radiation of a defined wavelength when irradiated by an excitation beam emitted from an excitation source, such as a LASER beam emitted from a LASER, of a commensurate wavelength; providing a source for emitting said excitation beam, such as a LASER beam, oriented as to aim at said labelled sample, wherein said sample is present inside a microfluidic channel or chamber thereof for holding said labelled sample during said irradiation; and providing a reflective layer positioned to reflect said electromagnetic radiation, providing a detector positioned to detect and optionally amplify said electromagnetic radiation, irradiating said sample with said LASER beam and analyzing said amplified electromagnetic radiation from said detector with a signal processing block. The labelled sample may be present inside a microfluidic channel of a microfluidic chip, or a specific part or chamber thereof, during said irradiation, wherein the sample may be encapsulated within a microfluidic droplet that passes through the microfluidic channel of the chip. In one embodiment the method may additionally comprise providing said microfluidic chip comprising one or more microfluidic channels and/or said chamber for holding the sample during irradiation.

In a specific aspect, the present invention relates to a method for detecting and or reflecting the fluorescence according to said system comprising the steps of providing a labelled sample wherein said labelled sample emits an electromagnetic radiation of a defined wavelength when irradiated by a LASER beam of a commensurate wavelength, providing a source for emitting said LASER beam, oriented as to aim at said labelled sample, providing a chamber for holding said labelled sample during said LASER irradiation, providing a reflective layer positioned to reflect said electromagnetic radiation, providing a detector positioned to detect and optionally amplify said electromagnetic radiation, irradiating said sample with said LASER beam and analyzing said amplified electromagnetic radiation from said detector with a signal processing block.

In another embodiment of the present invention the method further comprises the steps of providing a lens for focusing and shaping said LASER beam on said sample and providing a signal processing block for analyzing said detector-amplified electromagnetic radiation.

Herein, fluorescence refers to radiation produced by a substance that has absorbed another radiation, which has a longer wavelength than the radiation which has been absorbed.

Herein, “LASER” refers to a device that generates an intense beam of coherent monochromatic electromagnetic radiation caused by stimulated emission of photons from excited atoms or molecules. Of course, the laser is not the only possible light source. Light sources include but are not limited to a LASER, a light bulb, an LED, or the like. Herein, the light sources other than the Lasers, could be coupled to a narrow filter to excite at wavelengths far from the detection bandwidth.

### BRIEF DESCRIPTION OF THE DRAWINGS

FIG. 1 illustrates a system [100] for fluorescence detection, according to the main embodiment of the present invention. The system [100] includes one or more excitation sources [102], a first dichroic mirror [104], and a microscope objective (MO) [106]. The system [100] may include some other components such as a mirror or a lens, without departing from the scope of the disclosure. The excitation beam passes through the sample and encounters the reflective layer [108] that is positioned behind the microfluidic channel or a chamber of the microfluidic channel comprising the sample (wherein the sample (e.g. droplet) is located between the excitation laser that impinges from the source and the reflector), the electromagnetic radiation emitted and scattered from the sample and reflected from the reflective layer reenters the microscope objective [106] and is reflected by the first dichroic mirror [104] towards the fluorescence detection area [114]. In the detection area the electromagnetic radiation reaches the second dichroic mirror [110A], wherein in (i) a certain portion of the electromagnetic radiation that was emitted, scattered and/or reflected from the sample and the reflective layer is reflected by the second dichroic mirror [110A] towards a first detector [112A] and in (ii) the electromagnetic radiation that passes the second dichroic mirror reaches the third dichroic mirror [110B], whereby again (i) a certain portion of the electromagnetic radiation is reflected by the third dichroic mirror [110B] towards the second detector [112B] and (ii) a certain portion passes the third dichroic mirror to reach the forth dichroic mirror [110C], the steps (i) and (ii) repeat also for the forth dichroic mirror and the third detector [112C] and for the fifth dichroic mirror [110D] and the fourth detector [112D]. The light passing through the fifth dichroic mirror [110D] is detected by the fifth detector [112E].

FIG. 2 illustrates different shapes and positioning of the reflective layers integrated into the microfluidics chip circuit according to the invention. This figure shows a top view of the microfluidic chip. The reflectors are the rectangles in the center, and the lines on both sides are the electrodes. The figure shows reflective layers with different shapes (square, rectangle) with different area of visualization of fluorescent signal and signal enhancement (small, large, squared opened surface).

FIG. 3 Illustrates the system of the invention. This figure shows the microfluidic channel with a plurality of excitation lasers projecting light on the channel from the bottom. In one configuration on the left, the lasers propagate in the channel and fluorescent light is generated and shines in all directions. In the configuration depicted on the right, the reflective layer reflects the fluorescent light towards the optical system for enhanced detection.

FIG. 4 This Figure depicts a microfluidic chip upon which the FADS process occurs, as seen from the top view. Droplets flow under the reflective layer in this configuration, in a way that fluorescence can be enhanced by reflecting the fluorescence towards the optical collection system. The microfluidic emulsion inlet inserts/injects droplets into a small chamber where they wait until they are ejected into a large chamber that is subject to the sheath flows provided by two symmetric microfluidic channels (spacers; here depicted as starting from the oil inlet), enabling then the spacing of the droplets for analyzing them one by one inside the chamber. If the irradiation of the sample triggers a signal of interest, which is detected by the detector and analyzed by the processing block, the electronic feedback energizes the electrode to generate an acoustic wave that effects and moves the droplet, which results in the sorting of the droplet. The substrate in this embodiment is lithium niobate wafer.

FIG. 5 shows on the left side a setup comprising one or more LASERs, a first dichroic mirror, a microscope objective that focusses the excitation beam on the sample comprised within a microfluidics chip. The right of the figure shows a system according to the invention that comprises one or more LASERs, a cavity formed by the reflective layer and the first dichroic mirror and a fluorescence detection system comprising five dichroic mirrors and five detectors, such as photomultipliers.

FIG. 6 shows two embodiments of a microfluidic chip according to the present invention: In one embodiment (left side) the reflective layer is embedded on the microfluidic chip (as shown in FIGS. 1, 2, 4 and 5) in the other embodiment (right side) the fluorescence is reflected with mirrors on the top of the microfluidic chip. The mirrors reflect the fluorescent light back towards the optical fluorescence detection system, if oriented forming with an angle different to 0° with the laser propagation (multiple A in the image) direction. PMT=photomultipliers.

FIG. 7 depicts a microfluidic channel according to the present invention with a laser line projected from below. In this situation, the fluorescence generated is propagated in all possible directions and the signal-to-noise ratio (SNR) is calculated as the ratio of the mean values of the amplitude detected per channel (Gates 2, 3, 4 and 5) and the mean of the background noise (Gates 6, 7, 8 and 9). From PMT1 to PMT4, the readouts span the visible spectrum, and the SNR is indicated above each graph.

FIG. 8 depicts a microfluidic channel according to the present invention with a laser line projected from below. In this situation, the fluorescence generated is propagated in all possible directions and the portion of it is reflected by the layers into the collection (detection) optics. The signal-to-noise ratio (SNR)—calculated as indicated in FIG. 7 caption above-evidences a SNR enhancement per detection channel.

FIG. 9 Steps for fabrication of microfluidic devices according to the present invention with features requiring a single lithography or multiple lithographies.

FIG. 10 Metal reflectance spectra as a function wavelength (source: https://www.quora.com/Which-materials-reflects-the-widest-spectrum-of-light-can-be-coated-to-a-curved-surface-and-is-also-easily-available).

### DETAILED DESCRIPTION OF THE INVENTION

The system and method according to the present invention combines microfluidics with an optical system for fluorescence detection and achieves due to the combined assembly of one or more reflective layers, a microfluidics chip and an optical system an improved high throughput detection of fluorescence on a single cell level.

The system and method of the present invention can be used for various biotechnological applications but might be particularly beneficial for high-throughput screening on a single cell level, aiming to detect rare and lowly expressed markers (protein, lipids, sugars, nucleic acids).

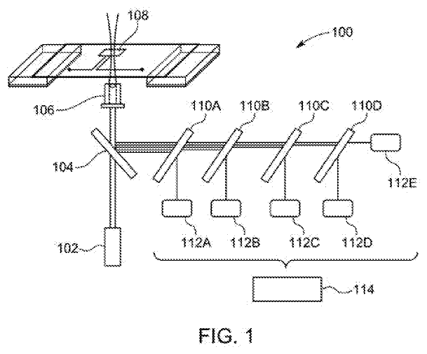

One aspect of the present invention is a system for detecting fluorescence comprising a labelled sample wherein said labelled sample emits an electromagnetic radiation of a defined wavelength when irradiated by a LASER beam of a commensurate wavelength, a source for emitting said LASER beam, oriented as to aim at said labelled sample, a chamber and/or channel for holding said labelled sample during said LASER irradiation, a reflective layer positioned to reflect said electromagnetic radiation, and a detector positioned to detect and optionally amplify said electromagnetic radiation. In addition to the reflected electromagnetic radiation, the detector also detects and amplifies electromagnetic radiation directly emitted from the sample not having been reflected by the reflective layer. Similarly, in addition to the emitted electromagnetic radiation, the reflective layer reflects the LASER beam. The labelled sample may be present inside a microfluidic channel, or a specific part or chamber thereof, during said irradiation, wherein the sample may be encapsulated within a microfluidic droplet that passes through the microfluidic channel (see for example FIGS. 1 and 3 to 5 depicting embodiments of the system according to the present invention). The labelled sample comprises a labelled biological cell. And said label comprises a fluorescent dye which further comprise BV421 and DY 777. A reflective layer is of a shape comprising rectangle or square, or circles, or any 2D shapes or a combination thereof. In some cases, the labelled samples are sorted after analysis using a method comprising acoustic actuation.

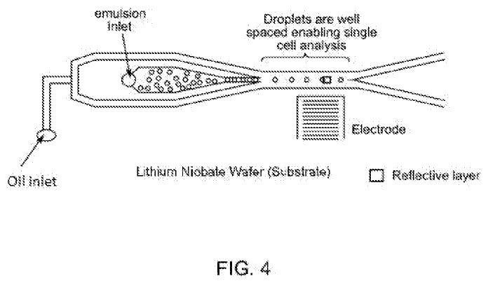

The system for detecting fluorescence of a sample within a microfluidic chip disclosed herein relies upon the provision of isolated droplets in a two-phase system (see for example FIG. 4). The fluid making up the droplets may be termed the dispersed phase, aqueous phase or sample phase, and this is typically a water or a water-based solution or suspension. The surrounding fluid may be termed the continuous phase or hydrophobic phase or oil-phase or sheath phase, which may usually be a nonpolar fluid, such as fluorocarbon oil, silicone oil, or vegetable oil, which is combined with water-based droplets to an emulsion. Surfactants may be added in one embodiment to both the dispersed and the continuous phase for increased droplet stability. The key feature of droplet microfluidics is the generation of monodisperse droplets that are completely isolated from each other, serving as miniaturized reaction vessels. The capability of creating individual reaction vessels on the scale of pico-liter to nanoliter volumes is extremely beneficial.

High throughput in droplet sorting is crucial in applications where large sample volumes are processed or in applications where the sample is extremely rare such as in directed evolution and in applications focused on isolating tumor cells.

In one embodiment, the system further comprises a lens for focusing and shaping the excitation beam, such as a LASER beam, on said sample and a signal processing block for analyzing said detector-amplified electromagnetic radiation.

In one embodiment the signal processing block comprises a plurality of detectors interfaced with a processing unit (FPGA) and can be operated/parametrized via software.

In one embodiment the detector may be one or more detectors selected from the group of photomultipliers (PMTs), photodiodes, CCD camera and/or CMOS detector, avalanche photodiodes and/or laser diodes.

In one embodiment, the system further comprises a lens for focusing and shaping said LASER beam on said sample and a signal processing block for analyzing said detector-amplified electromagnetic radiation.

In one embodiment of the present invention relates to a method for detecting and or reflecting the fluorescence according to said system comprising the steps of providing a labelled sample wherein said labelled sample emits an electromagnetic radiation of a defined wavelength when irradiated by an excitation beam emitted from an excitation source (FIG. 1 (102)), such as a LASER beam, of a commensurate wavelength, providing a source for emitting said excitation beam, such as a LASER beam, oriented as to aim at said labelled sample, providing a chamber for holding said labelled sample during said irradiation with an excitation beam (see e.g. FIG. 4), such as LASER irradiation, providing a reflective layer (FIG. 1 (108)) positioned to reflect said electromagnetic radiation, providing at least one detector (FIG. 1 (112)) positioned to detect and optionally amplify said electromagnetic radiation, irradiating said sample with said LASER beam and analyzing said amplified electromagnetic radiation from said detector with a signal processing block (FIG. 1 (114)).

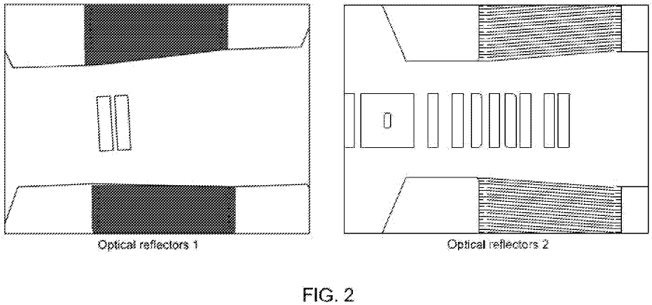

In another embodiment more than one reflective layer is comprised within the system of the present invention, two of such specific embodiments are shown, for example, in FIG. 2.

In another embodiment of the present invention the method further comprises the steps of providing a lens for focusing and shaping said LASER beam on said sample and providing a signal processing block for analyzing said detector-amplified electromagnetic radiation.

Herein, “electromagnetic radiation” refers to the waves or their quanta or photons of the electromagnetic field that radiate through space and carry electromagnetic radiant energy. Electromagnetic radiation comprises radio waves, microwaves, infrared, (visible) light, ultraviolet, X-rays, and gamma rays. The radiation, LASER, light, excitation or emission “beam” describes in the context of the present invention a beam of electromagnetic radiation of a certain wavelength. Herein, the term “radiation” and “electromagnetic radiation” may be used interchangeably.

Herein, “fluorescence” refers to radiation produced or emitted by a substance that has absorbed another radiation, which has a longer wavelength than the radiation which has been absorbed. In other words, upon excitation or irradiation with a certain wavelength a substance, a dye, a label or a sample might emit electromagnetic radiation of a certain wavelength, which can then be detected by one or more detectors. Optionally the emitted electromagnetic radiation might be transmitted and/or guided through and/or reflected by one or more mirrors, one or more dichroic mirrors, one or more lenses, one or more prisms, one or more filters and/or one or more reflectors or a combination thereof.

Herein a “filter” may refer to an optical component, typically having the characteristics and appearance of a film, which can select a specific wavelength of light or electromagnetic radiation or limit/narrow down the light or electromagnetic radiation to a wavelength band or wavelength range that can pass through it. For example, if two fluorophores overlap in their emission spectra, a filter can establish a cutoff wavelength for detecting the emission of only one of those fluorophores.

Herein, a “substrate” may comprise Lithium Niobate (LiNbO₃), Lithium Tantalate and/or Tellurium dioxide crystal, without being limited to these substances.

Luminescence describes the spontaneous emission of light by a substance caused by chemical reactions, electrical energy or subatomic motions. According to general definition the term “luminescence” comprises fluorescence, phosphorescence and chemiluminescence, wherein fluorescence and phosphorescence are forms of photoluminescence. In the context of the present invention specifically chemiluminescence and/or bioluminescence may be detected instead or in addition to the light emitted from an irradiated dye, label or sample.

Hence, in one embodiment of the present invention chemiluminescence and/or bioluminescence may be detected without irradiation of the sample by an excitation beam or in addition to the light emitted from an irradiated dye, label or sample, which is irradiated by an excitation beam before, after or at the same time, as the luminescence is emitted. In one embodiment the fluorescence and/or luminescence detection could be achieved in parallel by using filters and/or dichroic mirrors enabling the separation of electromagnetic radiation with different wavelengths that are emitted from the sample by luminescence and by emission upon irradiation. In this specific example it can be of advantage if the wavelength of the electromagnetic radiation emitted by luminescence is different from the wavelength of the electromagnetic radiation emitted, for example, from a dye or a probe upon irradiation of the sample with an excitation beam (coming from an excitation source).

Herein an excitation source or light source is a source that emits a beam of electromagnetic radiation. Herein “excitation sources” or “light sources” may comprise LASER, light bulbs (lamps), LEDs or superluminiscent diodes (that possess properties between lasers and LEDs). Herein, the terms “source”, “excitation source” and “light source” may be used interchangeably.

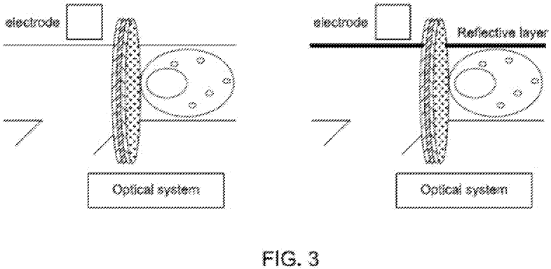

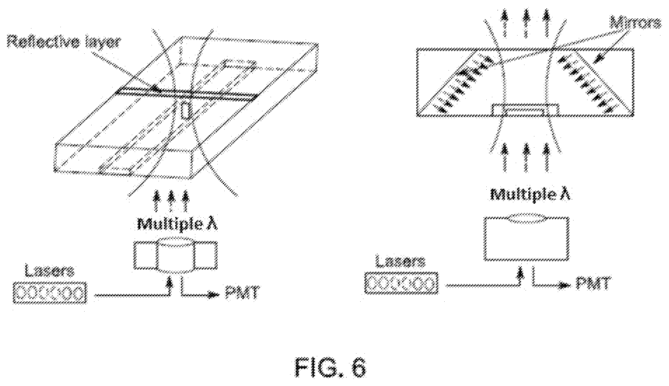

As depicted in FIGS. 3, 5 and 6 one or more excitation beams, such as one or more excitation or LASER beams of different wavelengths, emitted from one or more excitation sources might be used to irradiate a sample.

Herein, an “excitation beam”, “light beam” or “beam of electromagnetic radiation” might refer to a LASER beam, a beam of electromagnetic radiation or light emitted from an LED or a light bulb. Herein “emitted light”, “emitted electromagnetic radiation” or “emission beam” might be used interchangeable and may refer, in the respective context, to the electromagnetic radiation emitted from a sample after the irradiation by an excitation beam from an excitation source or by spontaneous chemi- or bioluminescence.

Herein, “LASER” refers to a device that generates an intense beam of coherent monochromatic electromagnetic radiation caused by stimulated emission of photons from excited atoms or molecules. Of course, the laser is not the only possible light source. Light sources include but are not limited to a LASER, a light bulb, an LED, or the like. Herein, the light sources other than the Lasers, could be coupled to a narrow filter to excite at wavelengths far from the detection bandwidth. In other words, the electromagnetic radiation or light that is emitted from a light or excitation source, such as an LED or a light bulb, may be directed towards a filter before irradiating/contacting the sample. Consequently, the excitation wavelength of the electromagnetic radiation or light might be reduced, manipulated, changed or directed to a desired bandwidth or wavelength, which preferably differs to a certain degree from the bandwidth or wavelength that is emitted from the sample or the label of the sample after the irradiation. In a specific embodiment the wavelength or bandwidth that passes through the filter is specific for the dye or label used in the sample. In one embodiment the light or electromagnetic radiation emitted from the source is not restricted to a certain and/or not directed through a filter wavelength.

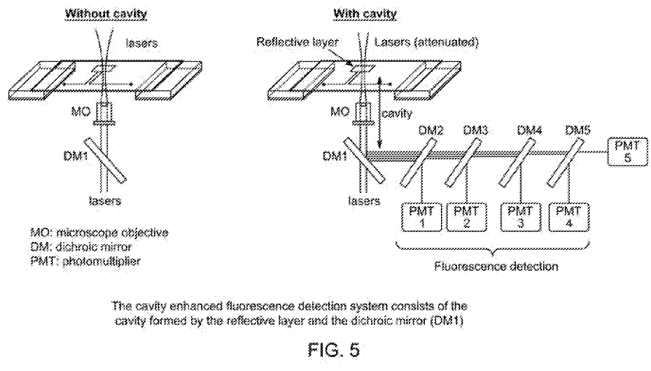

A “dichroic mirror” describes a reflector that reflects only electromagnetic radiation of a certain wavelength or range of wavelengths, while letting the (remaining) electromagnetic radiation with a different wavelength or range of wavelengths pass through. Examples of dichroic mirrors according to the invention are schematically depicted in FIG. 1 (104, 110 A-D) and FIG. 5 (DM1-5).

In a special embodiment the light or electromagnetic radiation scattered or reflected from the sample after irradiation may be also detected in a way that facilitates the calculation or estimation of the surface properties, the size and/or shape of the sample comprised within a microfluidic droplet, which might be a cell. This detection of scattered and/or reflected radiation might be performed before, after or in parallel to the detection of the light or electromagnetic radiation of a certain wavelength emitted from the sample or a label.

In one embodiment the system for detecting fluorescence comprise a labelled sample comprised within a droplet, wherein said labelled sample emits an electromagnetic radiation of a defined wavelength when irradiated by a excitation beam of a commensurate wavelength from an excitation source, which is oriented as to aim at said labelled sample, a chamber for holding said labelled sample during said irradiation, wherein said chamber may be a microfluidic channel or a part thereof comprising the sample inside a droplet, at least one reflective layer positioned to reflect said electromagnetic radiation emitted from the sample and/or from the excitation source, a detector, which is able to detect and optionally amplify detected electromagnetic radiation signals, positioned to detect and, optionally, amplify said electromagnetic radiation.

In another embodiment of the system for detecting fluorescence, the system additionally comprises at least a first and a second dichroic mirror, wherein said first dichroic mirror is positioned between said source and said chamber comprising said sample, wherein said chamber might be a microfluidic channel or a part thereof comprising the sample inside a droplet, and wherein said second dichroic mirror is positioned between said first dichroic mirror and said detector, wherein said first dichroic mirror deflects said electromagnetic radiation reflected from said reflective layer towards said second dichroic mirror which further deflects to said detector.

In another embodiment the system further comprises a lens for focusing and shaping said excitation beam on said sample and a signal processing block for analyzing said detector-amplified electromagnetic radiation.

In one embodiment of the present invention the lens for focusing is a microscope objective (such as “104” of FIG. 1 and “MO” of FIG. 5). The use of a microscope objective in the system according to the present invention provides numerous advantages over using a simple lens. One advantage is that shorter working and/or focal distances can be used with a microscope objective, thus enabling more sensitive detection and minimizing optical losses in the optical path. Also a higher magnification is possible when using a microscope objective instead of a simple lens, which is of advantage or even essential when using a in microfluidics system, e.g. as described herein, to visualize objects flowing in the microfluidic channels or chambers. Consequently a microscope objective might be a necessary feature to allow accurate droplet and/or cell sorting and/or monitoring. The use of a microscope objective also facilitates the use of oil and water, silicon or immersion microscopy, which enables enhanced fluorescence detection and minimize losses by optical refraction index variations. In addition, when coupled to a sensing or detection system the microscope objective enables simultaneous imaging, excitation and collection/detection of the generated electromagnetic radiation signals (such as, for example, emitted fluorescence, emitted luminescence, or scattered electromagnetic radiation). In summary, the system according to the present invention provides, at least due to the afore listed advantages and improvements, an improved detection of electromagnetic radiation signals (e.g. fluorescence and/or luminescence) emitted from a sample, such as a droplet, when comprising a microscope objective (such as “104” of FIG. 1 and “MO” of FIG. 5).

Herein, a “signal processing block” may comprise any processor, circuit or integrated circuit, such as Field Programmable Gate Arrays (FPGAs). A signal processing block comprises in one embodiment at least one or a plurality of detectors, which are interfaced with a processing unit or processing block (for example an FPGA) and can be operated/parametrized via a software. In another embodiment a signal processing block (e.g. FIG. 1 (114)) comprises at least one or a plurality of detectors (e.g. FIG. 1 (112)).

In a preferred embodiment the signal processing system or signal processing block may comprise least one or a plurality of detectors and either a FPGA or one or more data acquisition cards driven by dedicated software, programs and or codes, by machine learning process and/or by an image processing software.

In one embodiment once signals are detected and optionally amplified by a detector they are processed by a real time software enabling the screening and selection of populations of droplets containing signals of interest. Upon a selection, certain droplet populations can get sorted selectively to enable accurate separation of droplets (see for example FIG. 4). Such screening process might in one embodiment be graphically represented, and/or droplet sorting might be visually evidenced in real time videos.

Herein, a “chamber” may be a specific part of the microfluidic device and/or the microfluidic channel, wherein the sample and/or one or more microfluidic droplets comprising a sample may be positioned, lined-up or queued to be irradiated by the excitation beam. In one embodiment the one or more reflective layers might be positioned on one or more walls of the chamber, for example opposite or in another predefined angle to the excitation source, such that a sample is positioned inside the chamber between a reflective layer and an excitation source. The reflection of the fluorescence light emitted from the sample after irradiation can be achieved with the reflective layer(s) of the microfluidic chip surrounding the microfluidic channel walls, as indicated in FIGS. 3 and 4, or using external mirrors or reflective layers. In all cases the aim is to enhance the amount to light or electromagnetic radiation arriving at the detectors.

Herein a “patient” or “subject” may be selected from the group comprising, without being limited to, animals, mammals, humans, cell cultures and/or microbiological cultures.

A “sample” in the meaning of the invention can be all biological samples, a patient sample, all types of cells, cell extracts or cell lysates, proteins, lipids, sugars, nucleic acids, tissues and all biological fluids such as lymph, urine, cerebral fluid, blood, saliva, sputum, oral fluids, serum, feces, plasma, cell culture or cell culture supernatant, and any solution, emulsion, suspension or extract thereof. A sample may be solid or liquid or an emulsion. Tissues may be, e.g. epithelium tissue, connective tissue such as bone or blood, muscle tissue such as visceral or smooth muscle and skeletal muscle and, nervous tissue. The sample is collected from the patient or subjected to the diagnosis according to the invention.

A “sample” in the meaning of the invention may also be a sample originating from an environmental source, such as a plant sample, a water sample, a soil sample, or may be originating from a household or industrial source or may also be a food or beverage sample.

A “sample” in the meaning of the invention may also be a sample originating from a biochemical or chemical reaction or a sample originating from a pharmaceutical, chemical, or biochemical composition.

In a specific embodiment of the present invention the sample, such as a suspension of cells, a solution comprising proteins and/or nucleic acids may be supplied as an emulsion or a plurality of droplets comprising portions of the sample, such as single cells or components of single cells encapsulated in said droplets.

Where appropriate, as for instance in the case of solid samples, the sample may need to be solubilized, homogenized, or extracted with a solvent prior to use in the present invention in order to obtain a liquid sample. A liquid sample hereby may be a solution or suspension.

Liquid samples may be subjected to one or more pre-treatments prior to use in the present invention. Such pre-treatments include, but are not limited to dilution, filtration, centrifugation, concentration, sedimentation, precipitation, dialysis.

Pre-treatments may also include the addition of chemical or biochemical substances to the solution, such as acids, bases, buffers, salts, solvents, reactive dyes, detergents, emulsifiers, chelators.

“Nucleic acid”, in accordance with the present invention, includes DNA, such as cDNA or genomic DNA, and RNA. It is understood that the term “RNA” as used herein comprises all forms of RNA including mRNA as well as genomic RNA (gRNA), for example, of pathogens. In one embodiment, “RNA” is directed to gRNA of pathogens. In connection with DNA the rules for nomenclature of the International Union of Pure and Applied Chemistry (IUPAC) are used which are as follows: A is adenine, C is cytosine, G is guanine, T is thymine, R is G or A, Y is T or C, K is G or T, M is A or C, S is G or C, W is A or T, B is G or T or C (all but A), D is G or A or T (all but C), H is A or C or T (all but G), V is G or C or A (all but T), N is A or G or C or T (any). These symbols are also valid for RNA, although U replaces T (for uracil rather than thymine).

Nucleic acids may be obtained by amplification of a template nucleic acid, chemical synthesis or by extraction from a cell, such as a eukaryotic or procaryotic cell, or a viral particle or virus. Usually, cells are lysed or their cell membrane and/or cell wall is disrupted by chemical and/or mechanical means to extract nucleic acids and/or proteins from the cells. The lysis and extraction of nucleic acids and/or proteins from cells might be aided by the use of specific cell lysis reagents. In certain embodiments such reagents might comprise further ingredients or chemicals inhibiting the degradation and/or digestion of nucleic acids and/or proteins.

Herein a “biomarker” may be a protein, a nucleic acid or any other molecule or cellular component of interest suspected to be present within a sample.

A “biomarker”, “target nucleic acid” or “target nucleic acid sequence” may be present in the genome or in the entirety of genetic information of an analyzed cell in a sample and/or a subject.

A “biomarker”, “target feature”, “target protein” or “target protein sequence” or “target protein domain” may be present in the proteome or in the entirety of protein and peptide information of a sample. In accordance with the present invention, nucleic acid probes or antibodies may be used for detecting or labelling target molecules, such as biomarkers, nucleic acids or proteins, wherein the probes or antibodies have been attached, e.g. covalently attached, to fluorescence dyes or fluorophores. In the context of the present invention, fluorescent dyes or labels may for example be FFAM (5- or 6-carboxyfluorescein), VIC, NED, Fluorescein, FITC, IRD-700/800, CY3, CY5, CY3.5, CY5.5, Cy7, Xanthen, HEX, TET, TAMRA, JOE, ROX, BODIPY TMR, 6-Carboxy-2′,4′,7′,4,7-hexachlorofluorescein (HEX), TET, 6-Carboxy-4′,5′-dichloro-2′,7′-dimethodyfluorescein (JOE), N,N,N′,N′-Tetramethyl-6-carboxyrhodamine (TAMRA), 6-Carboxy-X-rhodamine (ROX), 5-Carboxyrhodamine-6G (R6G5), 6-carboxyrhodamine-6G (RG6), Rhodamine, Rhodamine Green, Rhodamine Red, Rhodamine 110, BODIPY dyes, such as BODIPY TMR, Oregon Green, Coumarines such as Umbelliferone, Benzimides, such as Hoechst 33258; Phenanthridines, such as Texas Red, Yakima Yellow, Alexa Fluor, PET, Ethidiumbromide, Acridinium dyes, Carbazol dyes, Phenoxazine dyes, Porphyrine dyes, Polymethin dyes, Oregon Green, Rhodamine Green, Rhodamine Red, Amber/Texas Red, Biosearch Blue™, Marina Blue®, Bothell Blue®, CAL Fluor® Gold, CAL Fluor® Red 610, Quasar™ 670 or the like. Particular reporter probes may additionally comprise fluorescence quenchers.

Preferred fluorophores or fluorescent labels include, a fluorophore, preferably selected from the group of fluorophores comprising 5 or 6 carboxyfluorescein (FAM™), VIC™, NED™, fluorescein, fluorescein isothiocyanate (FITC), IRD-700/800, cyanine dyes, such as CY3™, CY5™, CY3.5™, CY5.5™, Cy7™, xanthen, 6-carboxy-2′,4′,7′,4,7-hexachlorofluorescein (HEX), 6-carboxy-1,4-dichloro-2′,7′-dichloro-fluorescein (TEM, 6-carboxy-4′,5′-dichloro-2′,7′-dimethodyfluorescein (JOE™), N,N,N′,N′-tetramethyl-6-carboxyrhodamine (TAMRA™), 6-carboxy-X-rhodamine (ROX), 5-carboxyrhodamine-6G (R6G5), 6-carboxyrhodamine-6G (RG6), rhodamine, rhodamine green, rhodamine red, rhodamine 110, Rhodamin 6G®, BODIPY dyes, such as BODIPY TMR, oregon green, coumarines, such as umbelliferone, benzimides, such as Hoechst 33258; phenanthridines, such as Texas Red®, California Red®, Yakima Yellow, Alexa Fluor® 350, Alexa Fluor® 405, Alexa Fluor® 430, Alexa Fluor® 488, Alexa Fluor® 500, Alexa Fluor® 514, Alexa Fluor®532, Alexa Fluor® 546, Alexa Fluor® 555, Alexa Fluor® 568, Alexa Fluor® 594, Alexa Fluor® 610, Alexa Fluor® 633, Alexa Fluor® 647, Alexa Fluor® 660, Alexa Fluor® 680, Alexa Fluor® 700, Alexa Fluor® 750, PET®, ethidium bromide, acridinium dyes, carbazol dyes, phenoxazine dyes, porphyrine dyes, polymethin dyes, Atto 390, Atto 425, Atto 465, Atto 488, Atto 495, Atto 520, Atto 532, Atto 550, Atto 565, Atto 590, Atto 594, Atto 620, Atto 633, Atto 647N, Atto 655, Atto RhoG6, Atto Rho11, Atto Rho12, Atto Rho101, BMN™-5, BMN™-6, CEQ8000 D2, CEQ8000 D3, CEQ8000 D4, DY 480XL, DY 485XL, DY-495, DY-505, DY-510XL, DY-521XL, DY-521XL, DY-530, DY-547, DY-550, DY-555, DY-610, DY-615, DY-630, DY-631, DY-633, DY-635, DY-647, DY-651, DY-675, DY-676, DY-680, DY-681, DY-700, DY-701, DY-730, DY-731, DY-732, DY-750, DY-751, DY-776, DY-780, DY-781, DY-782, 6 carboxy-4′,5′-dichloro-2′,7′-dimethoxy-fluorescein (JOE), TET™, CAL Fluor® Gold 540, CAL Fluor RED 590, CAL Fluor Red 610, CAL Fluor Red 635, IRDye® 700Dx, IRDye® 800CW, Marina Blue®, Pacific Blue®, Yakima Yellow®, 6-(4,7-Dichloro-2′,7′-diphenyl-3′,6′-dipivaloylfluorescein-6-carboxamido)-hexyl-1-O-(2-cyano-ethyl)-(N,N-diiso-propyl)-phosphoramidite (SIMA), CAL Fluor® Gold 540, CAL Fluor® Orange 560, CAL Fluor Red 635, Quasar 570, Quasar 670, LIZ, Sunnyvale Red, LC Red® 610, LC Red® 640, LC Red®670, and LC Red® 705. In a further preferred embodiment of the present invention the label is selected from the group of fluorophores consisting of Atto 465, DY-485XL, FAM™, Alexa Fluor® 488, DY-495, Atto 495, DY-510XL, JOE, TET™, CAL Fluor® Gold 540, DY-521XL, Rhodamin 6G®, Yakima Yellow®, Atto 532, Alexa Fluor®532, HEX, SIMA, Atto RhoG6, VIC, CAL Fluor Orange 560, DY-530, TAMRA™, Quasar 570, Cy3™, NED™, DY-550, Atto 550, Alexa Fluor® 555, PET®, CAL Fluor RED 590, ROX, Texas Red®, CAL Fluor Red 610, CAL Fluor Red 635, Atto 633, Alexa Fluor® 633, DY-630, DY-633, DY-631, LIZ, Quasar 670, DY-635, and Cy5™, quantum dot technology probes (Qdot probes). In a yet further preferred embodiment the label is selected from group of fluorophores consisting of FAM™, DY-510XL, DY-530, and Atto 550.

Often and preferably, a label may be used to detect or attached to a particular biomarker. The term biomarker (biological marker) describes: “measurable and quantifiable biological parameters (eg, specific enzyme concentration, specific hormone concentration, specific gene phenotype distribution in a population, presence of biological substances) which serve as indices for health- and physiology-related assessments, such as disease risk, psychiatric disorders, environmental exposure and its effects, disease diagnosis, metabolic processes, substance abuse, pregnancy, cell line development, epidemiologic studies, etc.” NIH standardized the definition of a biomarker as “a characteristic that is objectively measured and evaluated as an indicator of normal biological processes, pathogenic processes, or pharmacologic responses to a therapeutic intervention”. A biomarker may be measured on a biological sample (as a blood, urine, or tissue test), it may be a recording obtained from a person (blood pressure, ECG, or Holter), or it may be an imaging test (echocardiogram or CT scan). Biomarkers can indicate a variety of health or disease characteristics, including the level or type of exposure to an environmental factor, genetic susceptibility, genetic responses to exposures, markers of subclinical or clinical disease, or indicators of response to therapy. Thus, a simplistic way to think of biomarkers is as indicators of disease trait (risk factor or risk marker), disease state (preclinical or clinical), or disease rate (progression). Accordingly, biomarkers can be classified as antecedent biomarkers (identifying the risk of developing an illness), screening biomarkers (screening for subclinical disease), diagnostic biomarkers (recognizing overt disease), staging biomarkers (categorizing disease severity), or prognostic biomarkers (predicting future disease course, including recurrence and response to therapy, and monitoring efficacy of therapy).

Biomarkers may also serve as surrogate end points. The underlying principle is that alterations in the surrogate end point track closely with changes in the outcome of interest. Additional values of surrogate end points include the fact that they are closer to the exposure/intervention of interest and may be easier to relate causally than more distant clinical events. In the present case, samples may be taken from patients and specifically labelled in accordance with a surrogate endpoint analysis.

In one set of embodiments, the system additionally comprises a first and a second dichroic mirrors, said first dichroic mirror positioned between said source and said chamber, said second dichroic mirror positioned between said first dichroic mirror and said detector, wherein said first dichroic mirror deflects said electromagnetic radiation reflected from said reflective layer towards said second dichroic mirror which further deflects to said detector. The predefined angle of said first dichroic mirror to said source comprises ±45° and ±135° but precludes 180°. Also, the predefined angle of said reflective layer to said first dichroic mirror precludes 180°. In one embodiment, as it can be seen in FIGS. 1 and 5, a reflective layer might be positioned opposite of the excitation source (having an angle of about 180°). In another embodiment a reflective layer might have an angle selected from the group of 150°, 155°, 160°, 165°, 170°, 175°, 180°, 185°, 190°, 195°, 200°, 210°, 220°, 225°, 230°, between 175 and 185°, between 170 and 190°, between 175 and 180°, between 170 and 180°, between 180 and 190°, between 185 and 195°, between 160 and 200° or between 150 and 230° to the excitation source. If more than one reflective layers is comprised within the system, such as shown in FIG. 2, each reflective layer might have a different angle to the excitation source.

In another set of embodiments, the system further comprises a lens for focusing and shaping said excitation beam, such as a LASER beam, on said sample and a signal processing block for analyzing said detector-amplified electromagnetic radiation. In one case, the lens comprises a Powell lens. In another embodiment the lens is comprised within a microscope objective (see “104” of FIG. 1 and “MO” of FIG. 5).

FIG. 1 shows the system according to one set of embodiments comprising one or more excitation sources 102, a first dichroic mirror 104, and a microscope objective (MO) 106. In some cases, the system may comprise one or more additional mirror(s) to reflect the LASER beam towards the sample, without departing from the scope of the disclosure. The one or more excitation sources 102 may be configured for emitting a particular type of Light Amplification by Stimulated Emission of Radiation (LASER) i.e. laser beam. In certain embodiments, the one or more excitation sources 102 may correspond to a first excitation source and a second excitation source. The first excitation source may be a visible LASER and the second excitation source may be an Infrared (IR) LASER. In other embodiments, the source(s) is configured to emit LASER beam with a wavelength comprising the specific electromagnetic spectrum of range between and including 405 nm and 730 nm. Accordingly, the wavelength of the emitted electromagnetic radiation from the sample comprises the specific electromagnetic spectrum of range between and including 423 nm and 771 nm. The dichroic mirrors would be made of materials from the group comprising silica and germanium. The microscope objective would have an optical zoom within the range of 4×-40× in air/oil/water.

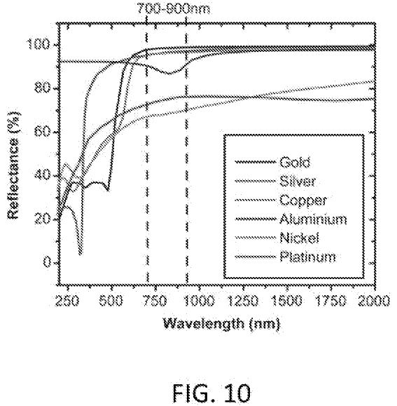

The one or more reflective layers and the chamber form part of a microfluidic chip manufactured by photolithography or chemical or physical etching. Furthermore, the microfluidic chip and/or a part thereof, such as the one or more reflective layers, would be manufactured using a material from the group of high reflectance metals for visible and infrared spectral radiation comprising titanium, platinum, gold and aluminum (See FIG. 10). The reflective layer would form a cavity in combination with said first dichroic mirror (see FIG. 5).

A rectangular reflective layer (such as depicted in FIGS. 1, 2 and 5) might have the dimensions of length×width or width×length selected from the group of 200 μm×50 μm, 100 μm×50 μm, 150 μm×50 μm, 100 μm×100 μm, 250 μm×150 μm, 200 μm×100 μm, a width or a length selected from the group of between 10 and 200 μm, between 50 and 200 μm, between 100 and 200 μm, but features can be customized at will very easily by modifying the mask for the lithography. The thickness of the metallic reflective layer deposited over the substrate (such as LiNbO₃) might be selected from the group of between 50 and 400 nm, between 100-400 nm, between 150 and 400 nm, between 200 and 400 nm, between 100 and 200, between 100 and 300, 50 nm, 100 nm, 150 nm, 200 nm, 250 nm, 300 nm, 350 nm, 400 nm, 450 nm, 500 nm.

Another aspect of the present invention is a method for detecting fluorescence according to said system comprising the steps of providing a labelled sample wherein said labelled sample emits an Electromagnetic radiation of a defined wavelength when irradiated by a LASER beam of a commensurate wavelength, providing a source for emitting said LASER beam, oriented as to aim at said labelled sample, providing a chamber for holding said labelled sample during said LASER irradiation, providing a reflective layer positioned to reflect said electromagnetic radiation, providing a detector positioned to detect and optionally amplify said electromagnetic radiation, irradiating said sample with said LASER beam and analyzing said amplified electromagnetic radiation from said detector with a signal processing block.

In one set of steps, the method additionally comprises providing a first and a second dichroic mirrors, providing said first dichroic mirror positioned between said source and said chamber, and providing said second dichroic mirror positioned between said first dichroic mirror and said detector, wherein said first dichroic mirror deflects said electromagnetic radiation reflected from said reflective layer towards said second dichroic mirror which further deflects to said detector.

In another set of steps, the method further comprises the steps of providing a lens for focusing and shaping said LASER beam on said sample and providing a signal processing block for analyzing said detector-amplified electromagnetic radiation.

Herein, a “detector” may be selected from the group comprising one or more semiconductor photodiodes, one or more avalanche photodiodes one or more photomultipliers (PMT; FIG. 5), one or more avalanche photodiodes, one or more laser diodes, one or more CCD camera and/or CMOS detector, or any combination thereof.

In one embodiment a signal processing system or fluorescence analysis system could be one or more FPGAs or one or more data acquisition cards driven by dedicated software, programs and/or codes, machine learning process and/or image processing tools. The use of photomultipliers as detectors (see, for example, FIG. 5) facilitates the detection and amplification of the detected electromagnetic radiation signal, which enables the detection of even weak signals and therefore improves the sensitivity of the system.

Herein, a “reflective layer” may comprise and/or may be manufactured from one or more of the metals selected from the group of aluminum (Al), platinum (Pt), gold (Au), titanium (Ti), chromium (Cr), copper (Cu), tin (Sn) and zinc (Zn).

Herein, the reflective layer might be positioned on at least one the wall of the microfluidics channel, for example inside a microfluidics channel or outside of the wall of the channel. The reflective layer may be positioned opposite of the path of the incoming excitation beam (see FIGS. 1 and 5) or at a certain predefined angle.

Herein the terms “reflective layer” and “reflector” may be used interchangeably.

In one embodiment and as depicted in FIG. 2, more than one reflective layer might be comprised within the system according to the invention. In one embodiment there might be a series of reflective layers positioned in a consecutive order, for example, along the microfluidic channel, such that a droplet passes one reflective layer after the other.

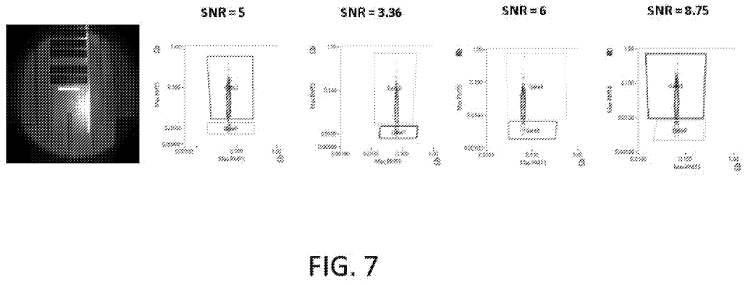

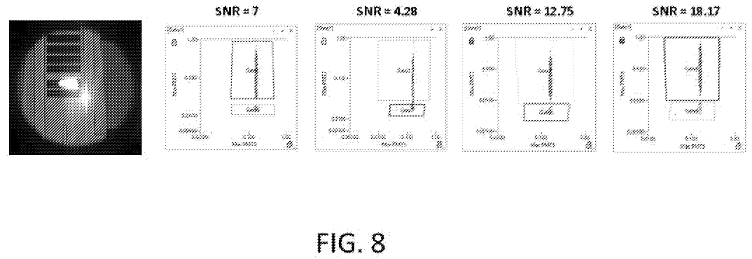

The effect achieved by the reflective layer that is positioned according to the invention is the improvement of fluorescence detection by reflecting fluorescence, which is not emitted directly towards the first dichroic mirror, back towards said first dichroic mirror. Thereby a higher percentage of the fluorescence or electromagnetic radiation that is emitted from the sample reaches the detectors or detection/analysis region of the system described herein. Therefore, the reflective layer of the present invention increases the percentage of emitted fluorescence which actually reaches the detectors and thereby facilitates the detection of even weak signals that are emitted from a sample. Hence, the system according to the present invention and comprising a reflective layer facilitates an improved fluorescence signal detection, as evidenced, for example, in the Example and FIG. 8 when compared to FIG. 7.

Single cell resolution of detected/recovered fluorescence can be achieved with a reflective layer that can be as small as a cell (3-120 μm), which outperforms existing means, such as embedded concaves lenses, which are in general bulkier (millimetric scale). Having a bulkier reflective surface can lead to signal cross-talk from two cells that are close to each other. Moreover, implementation and/or fabrication of existing means, such as concave lenses, requires a perfect alignment of the optics with the fluidics, making this approach sensitive to mis-alignment and error-prone, and therefore not feasible for implementation in microfluidics systems or chips. The reflective layer according to the invention on the other hand, can be fabricated with the same techniques used for fabrication of the microfluidics chip. A single lithography could deposit reflectors and electrodes at once, if the same metal is used, or in two steps if different metals or materials are used. Moreover, another advantage of the present invention is that the planar surface of a reflective layer does not require such a precise alignment of the excitation source with the moving or mobile irradiation target, such as a droplet, inside a microfluidics channel or chamber. Moreover, as a reflective layer according to the present invention, is preferentially embedded into the microfluidic channel and/or a cross-section thereof, it is insensitive to proximity effects of the external optics and thus attains enhanced detection in comparison to prior art systems.

Consequently, the system according to the present invention comprising a reflective layer in combination with a microfluidics chip provides an improved feasibility and sensibility of the detection, analysis and sorting of fluorescence at a single droplet-scale and/or on a single-cell level (as evidenced, for example, in the Example and FIG. 8, when compared to FIG. 7). In addition, the system according to the present invention is easier to fabricate and less error-prone than state of the art systems for fluorescence analysis using lenses for reflecting or focusing fluorescence and/or other electromagnetic radiation beams.

Herein, the microfluidics device or microfluidics chip may be fabricated completely or partially from one or more of the materials selected from the group of high reflectance metals for visible and infrared spectral radiation (see FIG. 10) comprising aluminum (Al), platinum (Pt), gold (Au), titanium (Ti), chromium (Cr), copper (Cu), tin (Sn) and zinc (Zn) or a combination thereof.

Herein, a microfluidic chip may comprise one or more microfluidic channels, at least one outlet, at least one inlet, at least one sorting means or section, at least one reflective layer, at least one chamber, one or more linear and/or branched fluidics comprising a water-solution, a water-in-oil emulsion, an oil-in-water emulsion or a double emulsion (see, for example, FIG. 4). Specific embodiments of the present invention are depicted in FIGS. 1, 4 and 5.

Herein, the sorting of labelled sample or droplets inside the microfluidic system may be achieved by a sorting means or any sorting mechanism known in the field of microfluidics, such as the techniques outline herein, for example, acoustic actuation, FADS, MAP, SAW, BAW, SSAW, TSAW or DEP, prior or after analysis and may be based on the detected light scattering, fluorescence detection, luminescence detection, events detection and/or combination of events detection via mathematical functions or a combination of one or more thereof.

In a special embodiment the sorting of a sample and/or a droplet is achieved by a method comprising acoustic actuation.

The disclosed invention encompasses numerous advantages. Various embodiments of a reflective layer enhanced fluorescence detection system and method are disclosed. Such reflective-layer enhanced fluorescence detection system allows maximum emitted fluorescence to reach a detector and thus results in increasing efficiency of detection of biological cells.

Further, the reflective layer enhanced fluorescence detection system improves detection thresholding at low fluorescent levels by increasing and filtering signals in the violet-blue region. Such method and system increase collected power and gain of at least 20 percent of the fluorescence of violet-blue color, the fluorescence of red color, and the infrared fluorescence. Therefore, such system and method for improving fluorescence detection result in increased efficiency, power, and gain of the fluorescence detection system.

The invention also relates to a method for detecting and/or measuring the fluorescence from a sample comprising providing for a system according to the invention, providing for a labelled sample, and detecting and/or measuring the fluorescence emitted from said sample.

Fluorescence refers to the emission of electromagnetic radiation, especially of visible light, stimulated in a substance by the absorption of incident radiation and persisting only as long as the stimulating radiation is continued, as well as the emitted electromagnetic radiation itself.

As used herein detecting means, determining whether or not a defined and specified sample type is present in an assay to be performed. Herein, the radiation emitted by the labelled sample is used as an indicator for said detection.

As used herein measuring may mean measuring the emission's i) wavelength or ii) the amplitude.

Measuring and detecting may also be done for a sample that comprises more than one label type.

The whole set of detection over different spectral bands is enhanced by placing the laser under the reflective layers with droplets passing below the embedded reflectors. It is observed that the detection efficiency is improved by around at least 15% with the gold layer and around 27% with the aluminum layer in the spectral band 405-440 nm.

### EXAMPLES

Improved Detection of Electromagnetic Radiation Signals

The herein disclosed methods and systems enable the combination of imaging, excitation and detection, thereby achieving an improved detection of fluorescence, fluorescently labeled cells or of fluorescent beads at multiple wavelengths.

In the examples disclosed in FIGS. 7 and 8, the microfluidic device is imaged from below. The laser line (=excitation beam) is generated by propagating the emitted excitation beams through a Powell lens, and then through a microscope objective. This scheme enables simultaneous imaging, excitation, and detection of optical signals (=emitted electromagnetic radiation from a sample) within the chip.

Imaging is the quality method employed in this system to verify that accurate sorts are performed. Sorted droplets are visualized as they are deflected from a mainstream of droplets.

Excitation is achieved via the laser line (LASER or excitation beam) projected orthogonally with respect to the droplet stream. Droplet pass one by one, and fluorescence is generated when the in-droplet content is irradiated.

The detection works two-folds:

When the laser (or excitation) beam propagates across the channel cross section without the reflectors (reflective layer(s)) on its path, the generated fluorescence, that is emitted from the sample, propagates isotopically, and only a portion of it reaches the detection optics and is collected by it. This is the situation evidenced in FIG. 7. As the system detects only a portion of the generated fluorescence (light), optical losses are intrinsic to this configuration.

When the configuration depicted in FIG. 8 is used, the reflectors (reflective layer(s)) enable fluorescent light to be “reinjected” (reflected back) into the detection optics. This configuration increases the amplitude of the detected signals, and the signal-to-noise ratio is enhanced in all detection channels by 28% in PMT1 (photo multiplier 1; see e.g. FIG. 1: 112A and FIG. 5: scheme on the right side), 21% in PMT2 (see e.g. FIG. 1: 112B and FIG. 5: scheme on the right side), 52% in PMT3 (see e.g. FIG. 1: 112C and FIG. 5: scheme on the right side) and 51% in PMT4 (see e.g. FIG. 1: 112D and FIG. 5: scheme on the right side). Enhancement percentage E_{%} is calculated as:

E_{%}=[1−(SNR_{w/o}/SNR_{with})]*100

where SNR_{w/o} is the signal-to-noise ratio without the reflectors and SNR_{with} is the signal to noise ratio obtained with the reflectors.

With this configuration, optical losses are decreased and therefore the signal-to-noise ratio is increased and detection and therefore sensitivity is significantly improved. A clear separation of the signals is evidenced in the plots of FIG. 8, when compared to those shown in FIG. 7, meaning that the amplitude detected is high enough to separate the signals of interest from the detectors' intrinsic noise.

The configuration enabling these on-chip reflectors detection enhancement is:
Powell Lens for laser line shaping: Laser Line Optics LOCP-8.9R10-2.0
Microscope Objective: Nikon CFI Super Fluor 40×/1.30 Oil Immersion Objective (MRF01400)
Immersion Oil: Thermo Fisher M2004
Laser Power: 405 nm-60 mW; 488 nm-60 mW; 561 nm-56 mW; 638 nm-100 mW; 730 nm-40 mW

Droplet Generation

Water-in-oil droplets are generated in a dedicated microfluidic chip where aqueous flows containing rainbow fluorescent beads (Biosciences 556298) converge at a channel junction with a symmetric oil phase using Novec 7500 supplemented with 2% fluorophilic surfactant (RAN). Beads are encapsulated and isolated in these droplets. The generated droplet stream is collected in a reservoir for further processing.

Droplet Reinjection

Generated droplets are flushed from the collection reservoir into a microfluidic device (called hereafter sorter) and they “roll out” in the chamber (see e.g. FIG. 4). Using two symmetrical sheath flows, the stream of droplets is organized to ensure that they propagate in line, one droplet at the time (one after the other).

Fabrication of the Planar/Flat On-Chip Reflectors

The fabrication process outlined herein enables the integration to a level where neither the alignment and/or integration with external parts, nor etching, graving and polishing is required. Therefore, the system of the present invention fabricated as described hereinafter facilitates optimized and more straight forward, but less error prone, fluorescence detection and sorting, as all essential features of the system are integrated in the system in a way that does not require the alignment of external (separate) parts, but enables the detection of specific signals attributable to one single droplet/cell with no detection crosstalk due to multiple reflections from a plurality of droplet; Therefore, providing a significant improvement over state-of-the art systems.

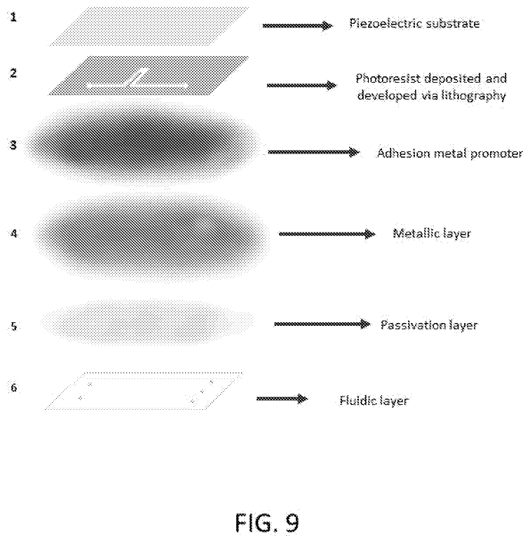

In a straightforward configuration, the (sorter-) chip fabrication steps can be summarized in six main steps indicated in FIG. 9.
1. Pattering the piezoelectric substrate with a pre-designed photolithographic mask enables the key features of the chip to be printed in the main substrate or piezoelectric substrate.

Following the photoresist deposition, the substrate is spin-coated with the resist, and exposed to a custom-made mask featuring the required operational structures over the chip. These features can be, for example, the chip's electrodes with the reflectors in a single mask if they are made of the same materials or alternatively, pattering in multiple lithographic exposures the electrodes and the reflectors separately, following the steps 1 to 4 with different materials for the deposition of the metallic layer.

If, for example, the electrodes are fabricated in gold and the reflectors in aluminum, then step 2 is restricted to using a photolithographic mask with the electrodes only, conduct the development phase and then perform steps 3 and 4 (with gold) successively. Then steps 2 to 4 are repeated with an aluminum metallic layer deposition in step 4.

If electrodes and reflectors are fabricated in the same material, for example, in gold or platinum, then the mask in step 2 is adapted to include all features and the process can be straightforwardly conducted.
2. One of the key features of this invention relies on incorporating on-chip reflectors, herein also referred to as reflective layers. Given that these reflectors are made of metallic flat layers, the fluorescence transmittances and reflectivities provided by them varies across the visible spectrum. In the blue-violet region aluminum is highly reflective, thus enhancing the detection of fluorophores in this band, whereas gold is only partially reflective in this spectral band. The visible region covering the green and up to near infrared reflect with equivalent performance both materials. Depending on the assay configuration, reflectors' materials may play a key role in fluorescent amplitude detection (see FIG. 10). Therefore, the chip fabrication customization is to be adapted to the assay, yet aluminium is most suitable for visible wavelength fluorescence detection. The present system therefore provides improved flexibility as it may be customized depending on the specific requirements of an assay or application.
3. Microfluidic chips with metallic depositions can be made in multiple materials, including glass and piezoelectric substrates. Reflectors embedded on the channel walls use the same procedure detailed in FIG. 9 during the fabrication process. On the other hand, depending on the application, the electrodes are patterned and printed in materials tolerating the electrical energization.
4. The described process can yield flat features such as reflectors and electrodes distributed in variable in-plane geometries, and the flat deposition can be conveniently adapted to the size of the specimen that is to be sensed. In this way, and operating with an organized droplet stream, it is possible to ensure detection of specific signals attributable to one single droplet/cell with no detection crosstalk due to multiple reflections from a plurality of droplets.

What is claimed is:

1. A system for detecting fluorescence comprising:
a. a labelled sample wherein said labelled sample emits an electromagnetic radiation of a defined wavelength when irradiated by a LASER beam of a commensurate wavelength,
b. a source for emitting said LASER beam, oriented as to aim at said labelled sample,
c. a chamber for holding (mobile or immobile) said labelled sample during said LASER irradiation,
d. a reflective layer positioned to reflect said electromagnetic radiation,
e. a detector positioned to detect and amplify said electromagnetic radiation.

2. The system according to claim 1, additionally comprising:
a. a first and a second dichroic mirrors,
b. said first dichroic mirror positioned between said source and said chamber,
c. said second dichroic mirror positioned between said first dichroic mirror and said detector,
wherein said first dichroic mirror deflects said electromagnetic radiation reflected from said reflective layer towards said second dichroic mirror which further deflects to said detector.

3. The system according to claims 1 and 2, further comprising:
a. a lens for focusing and shaping said LASER beam on said sample,
b. a signal processing block for analyzing said detector-amplified electromagnetic radiation.

4. The system according to claims 1 to 3, wherein said detector also detects and amplifies said electromagnetic radiation directly emitted from said sample without being reflected by said reflective layer.

5. The system according to claims 1 to 4, wherein said reflective layer also reflects said LASER beam.

6. The system according to claims 1 to 5, wherein said LASER beam's wavelength comprises the visible and the infrared electromagnetic spectra.

7. The system according to claims 2 to 6, wherein a predefined angle of said first dichroic mirror to said source comprises ±45° and ±135° but precludes 180°.

8. The system according to claims 2 and 7, wherein a predefined angle of said reflective layer to said first dichroic mirror precludes 180°.

9. The system according to claims 1 to 8, wherein said labelled sample comprises a labelled biological cell.

10. The system according to claims 1 to 9, wherein said label comprises a fluorescent dye.

11. The system according to claim 10, wherein said fluorescent dye comprises streptavidin-BV421 and DY 777.

12. The system according to claims 1 to 11, wherein said reflective layer is of a shape comprising rectangle and square or a combination thereof.

13. The system according to claims 1 to 12, wherein said electromagnetic radiation's wavelength comprises the specific electromagnetic spectrum of range between and including 423 nm and 763 nm.

14. The system according to claims 1 to 13, wherein said source is configured to emit a LASER beam with a wavelength comprising the specific electromagnetic spectrum of range between and including 405 nm and 730 nm.

15. The system according to claims 3 to 14, wherein said lens comprises a Powell lens.

16. The system according to claims 1 to 15 comprising one or more additional mirror(s) to reflect said LASER beam towards said sample.

17. The system according to claims 1 to 16, wherein said reflective layer and said chamber constitute parts of a microfluidic chip manufactured by photolithography.

18. The system according to claims 1 to 17, wherein said microfluidic chip is manufactured using a material from the group of high reflectance metals for visible and infrared spectral radiation comprising titanium, platinum, gold and aluminum.

19. The system according to claims 1 to 18, wherein said labelled samples are sorted prior to analysis using a method comprising acoustic actuation.

20. The system according to claims 1 to 19, wherein said reflective layer forms a cavity in combination with said first dichroic mirror.

21. A method for detecting and/or measuring the fluorescence from a sample comprising:
i. providing for a system according to claims 1 to 20,
ii. providing for a labelled sample,
iii. detecting and/or measuring the fluorescence emitted from said sample.
